(19) United States
(12) Patent Application Publication
(10) Pub. No.: US 2009/0245672 A1
(43) Pub. Date: Oct. 1, 2009

(54) ENTROPY ENCODING CIRCUIT AND ENCODING METHOD THEREOF

(75) Inventors: Chia-Ping Lin, Kaohsiung City (TW); Chao-Tsung Huang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/188,194

(22) Filed: Aug. 7, 2008

(30) Foreign Application Priority Data
Mar. 25, 2008 (TW) 97110532

(51) Int. Cl. G06K 9/54

(52) U.S. Cl. 382/243

(57) ABSTRACT

An entropy encoding circuit having two entropy encoders is provided. A first encoding procedure performs an adaptive scan on the encoding coefficient, and the second encoding procedure performs a fixed scan on the encoding coefficient. One of the entropy encoders receives a first encoding coefficient and performs the first encoding procedure on the first encoding coefficient to output a first encoded stream data. The other entropy encoder receives a second encoding coefficient and a normalization signal and performs the second encoding procedure on the second encoding coefficient according to the normalization signal to output a second encoded stream data. The entropy encoding circuit alternatively outputs the first encoded stream data and the second encoded stream data.

### CROSS-REFERENCE TO RELATED APPLICATION

This application claims the priority benefit of Taiwan application serial no. 97110532, filed on Mar. 25, 2008. The entirety of the above-mentioned patent application is hereby incorporated by reference herein and made a part of specification.

### BACKGROUND OF THE INVENTION

1. Field of the Invention

The present invention generally relates to a data processing apparatus and an operating method thereof, in particular, to an encoding circuit which can simultaneously encode TILE_HIGHPASS and TILE_FLEXBITS and an encoding method thereof.

2. Description of Related Art

A general image compression method is to transform and encode an original image data into an encoded stream, as shown in FIG. 1. The image compression method includes following steps. First, in step 110, downsampling and color space transform are performed. Then, in step 120, lapped transform (LT) is performed. Next, in step 130, quantization and coefficient predication are performed, and a coded block pattern is generated. After that, in step 140, adaptive scan and entropy coding are performed to generate the encoded stream.

Taking the Joint Photographic Experts Group (JPEG) standard as an example, the image is first transformed into a YCbCr color space, then discrete cosine transformation and quantization are performed, predication differentiation is then performed to the DC coefficient, finally, the coefficient is scanned into a run-length encoding in a zig-zag scanning order, and a variable length coding is performed to complete the encoding procedure.

A new static image compression format provided by Microsoft Corporation, referred as HD Photo format, is under consideration for a JPEG standard and is tentatively titled JPEG-XR. According to the HD Photo format, LT in unit of 4*4 blocks is adopted to avoid the de-blocking effect caused by independent blocks, wherein overlap filtering is first performed to the 4*4 blocks at the block junctions, and core transform is then performed to the 4*4 blocks, and a lift structure is adopted by both the overlap filtering and the core transform so as to ensure a lossless compression.

FIG. 2 is a flowchart illustrating an overlap filter transform and a core transform conforming to HD Photo format. These techniques are disclosed in U.S. Patent No. 2006/013682 titled “Reversible Overlap Operator for Efficient Lossless Data Compression” and U.S. Patent No. 2007/0036223 titled “Efficient Coding and Decoding of Transform Blocks”. Foregoing HD Photo format is adopted in these techniques, wherein the 2-dimensional input data illustrated in FIG. 2 is tiled, and then LT (the forward overlap filter transform illustrated in FIG. 2) is performed in order to avoid the de-blocking effect caused by independent blocks. After that, block transform (i.e. HD Photo core transform (PCT)) is performed on the originally tiled blocks to obtain a DC coefficient and fifteen AC coefficients. Since a two-level transform is adopted by this HD Photo format, the DC coefficient is combined into a block and overlap filter transform and block transform are performed once again.

A lift structure is adopted in foregoing overlap filter transform and core transform so as to ensure a lossless compression. Since each step in the lift structure is completely reversible, if a signal in lossless compression transform field is adopted in the encoding procedure, an image exactly the same as the original image can be obtained by performing a reversed core transform and then a reversed overlap filter transform during the decoding procedure. In the HD Photo format, whether to perform a first level overlap filter transform and a second level overlap filter transform can be self-determined. The DC coefficient and AC coefficients are quantized, entropy coded, and packetized to obtain a compressed bitstream.

There are many differences between the HD Photo specification and the JPEG standard. The differences include that the HD Photo format can accept a larger pixel value range and adopts a self-defined YCoCg color space, a self-defined two-level LT operation and a self-defined coefficient prediction operation. FIG. 3 is a diagram illustrating the result obtained by performing two-level transform according to the HD Photo format. In the entropy coding part, the coefficients can be categorized into different types according to different transformed positions. For example, the symbol 310 denotes a macroblock obtained through the first level transform, and the symbol 320 denotes all the DC values for buffering the results obtained through the first level transform. Next, the second level transform is performed, and the content of the LOWPASS block denoted by the symbol 330 is the result obtained through the second level transform. The result of the entire transform is divided into four different data including DC, LOWPASS, HIGHPASS, and FLEXBITS, and the image is then encoded according to foregoing data.

As shown in FIG. 3, a macroblock 310 is obtained through transformation, quantization, and coefficient prediction processes, wherein the macroblock 310 includes 16 microblocks, and each of the microblocks has 4*4 coefficients. These coefficient include a DC block Tile_DC and fifteen AC coefficients, and these AC coefficients are coefficients belonging to Tile_HIGHPASS and Tile_FLEXBITS. All the DC blocks Tile_DC are integrated into a 4*4 block denoted by the symbol 320 through the first level transform. The symbol 330 includes a DC coefficient and fifteen LOWPASS blocks (Tile_LOWPASS) denoted as LP in the figure.

The coefficients in a DC block Tile_DC are first normalized and then encoded. First, a coded block pattern is generated according to whether the normalized coefficient is zero, and the coded block pattern is encoded. Next, the normalized coefficient is encoded through self-defined adaptive variable length coding. Finally, the remaining bits of the normalized coefficient is encoded through fixed length coding, and whether the sign of the coefficient is encoded through fixed length coding is determined according to whether the coefficient is zero.

The encoding of a LOWPASS block Tile_LOWPASS is similar to that of a TILE_DC. After the coefficient is normalized, first, a coded block pattern is generated according to whether all the fifteen coefficients in the 4*4 block are zero and is encoded. Next, the normalized coefficient is converted into run-length encoding through an adaptive scanning order, and an adaptive variable length coding is then performed. The remaining bits of the normalized coefficient are encoded according to a fixed scanning manner through a fixed length encoding. A fixed length encoding is also performed to the sign of the coefficient when the coefficient is not zero while the normalized coefficient is zero.

The encoding of HIGHPASS block Tile_HIGHPASS and FLEXBITS block Tile_FLEXBITS is similar to that of TILE_LOWPASS, wherein the AC coefficients are encoded, the stream in TILE_HIGHPASS includes a coded block pattern and a normalized coefficient coding, and the stream in TILE_FLEXBITS includes the remaining bits of the normalization and the fixed length encoding of the signs of some coefficients.

The HD Photo format provides two different stream formats: spatial mode and frequency mode. The spatial mode is the same as the conventional coding, wherein macroblocks are connected, and each macroblock first has stream of DC tile Tile_DC and LOWPASS tile Tile_LOWPASS, namely, compressed bitstream. Then, the coding in each block is connected in order of HIGHPASS tile Tile_HIGHPASS and FLEXBITS tile Tile_FLEXBITS.

The other stream format is frequency mode, wherein tiles are integrated. Four different types of tiles are respectively encoded in the order of macroblock coding, and then the streams of these four types of tiles are connected.

According to the coding process of the HD Photo format described above, if the entropy encoding of the HD Photo format is implemented with hardware, because a normalization operation will be performed on a coefficient, then both the normalized coefficient and the remaining bits of the normalization process have to be encoded, which increase the number of clocks required for the operation and the efficiency of the process is reduced.

### SUMMARY OF THE INVENTION

Accordingly, the present invention is directed to an encoding circuit, for simultaneously performing a first encoding procedure and a second encoding procedure on an encoding coefficient. The first encoding procedure performs an adaptive scan on the encoding coefficient, and the second encoding procedure performs a fixed scan on the encoding coefficient. The encoding circuit includes a read/write control circuit, a first entropy encoder, a second entropy encoder, and a buffer device. The read/write control circuit reads and buffers the encoding coefficient and simultaneously outputs a first encoding coefficient and a second encoding coefficient. The first entropy encoder connects to the read/write control circuit. The first entropy encoder receives the first encoding coefficient, performs the first encoding procedure to the first encoding coefficient, and outputs a first encoded stream data. The second entropy encoder, connected to the read/write control circuit, receives the second encoding coefficient and a normalization signal, performs the second encoding procedure to the second encoding coefficient, and outputs a second encoded stream data. The buffer device, connected to the first entropy encoder and the second entropy encoder, buffers the first encoded stream data and the second encoded stream data and alternatively outputs the first encoded stream data and the second encoded stream data.

According to an embodiment of the present invention, the first encoding procedure and the second encoding procedure are respectively a coefficient entropy encoding procedure conforming to TILE_HIGHPASS and TILE_FLEXBITS of HD Photo specification.

The present invention provides an entropy encoding method. The method includes following steps. First, an encoding coefficient used for performing entropy encoding is buffered, and a first encoding coefficient and a second encoding coefficient are simultaneously provided, wherein the first encoding coefficient is obtained by performing an adaptive scan on the encoding coefficient, and the second encoding coefficient is obtained by performing a fixed scan on the encoding coefficient. Next, a first encoding procedure is performed according to the first encoding coefficient to output a first encoded stream data. At the same time, a normalization signal is received, and a second encoding procedure is performed according to the second encoding coefficient and the normalization signal to output a second encoded stream data. The first encoded stream data and the second encoded stream data are then buffered and outputted alternatively.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating how an original image data is transformed and encoded into an encoded stream according to a conventional image compression technique.

FIG. 2 is a flowchart illustrating an overlap filter transform and a core transform conforming to HD Photo format.

FIG. 3 is a diagram illustrating the result obtained by performing two-level transform according to HD Photo format.

FIG. 4 is a block diagram of an encoding circuit which can simultaneously encode TILE_HIGHPASS and TILE_FLEXBITS hardware structures according to an embodiment of the present invention.

FIGS. 4A and 4B are block diagrams of an encoding circuit which can simultaneously encode TILE_HIGHPASS and TILE_FLEXBITS hardware structures by respectively executing real-time normalization operation or advance normalization operation and storing the result in a normalized coefficient determination unit according to an embodiment of the present invention.

FIG. 5A is a block diagram of an encoding circuit which can simultaneously encode TILE_HIGHPASS and TILE_FLEXBITS hardware structures and is applied in an encoder.

FIG. 5B is a block diagram of an encoding circuit which can simultaneously encode TILE_HIGHPASS and TILE_FLEXBITS hardware structures by executing real-time normalization operation according to an embodiment of the present invention.

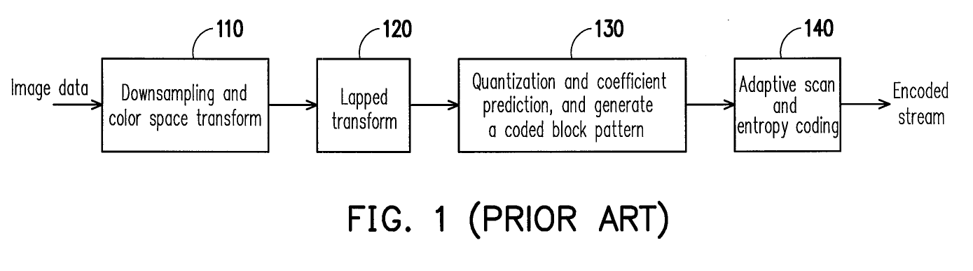

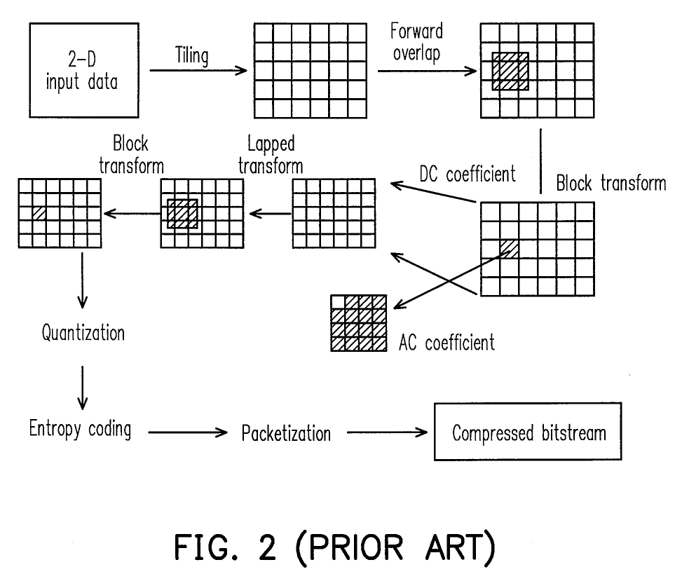

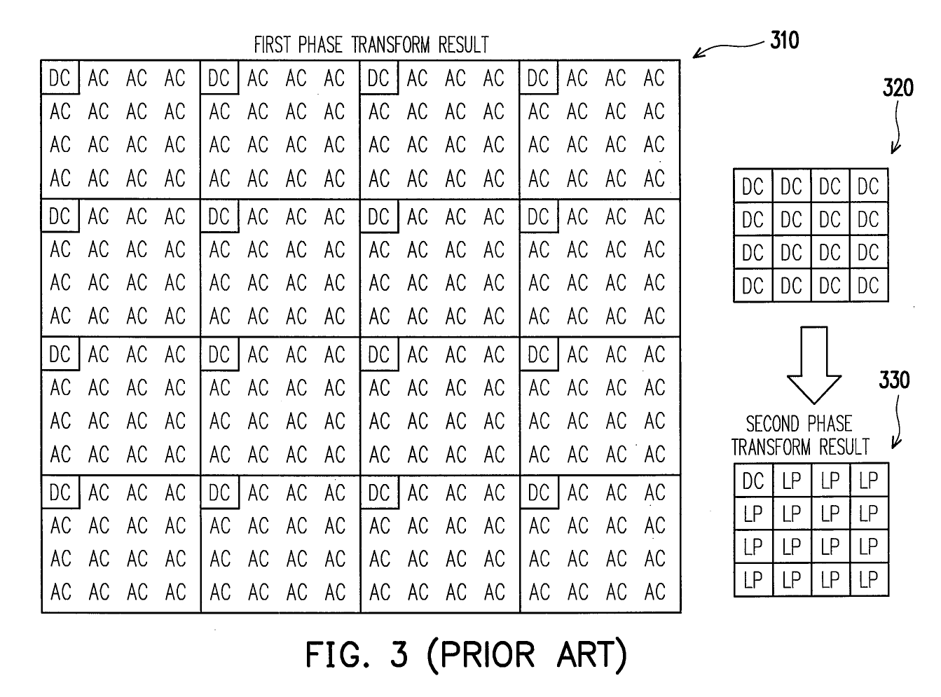

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the coding process of the HD Photo format, if the entropy encoding of the HD Photo format is implemented with hardware, because a normalization operation will be performed to a coefficient, then both the normalized coefficient and the remaining bits of the normalization process have to be encoded. In these processes, HIGHPASS tiles Tile_HIGHPASS and FLEXBITS tiles Tile_FLEXBITS encode all the AC coefficients, and which takes up to 90% of the coefficient of the image therefore is the most clock-consuming part of the entropy encoding of HD Photo format.

The present invention provides a hardware structure which can encode both TILE_HIGHPASS and TILE_FLEXBITS of the HD Photo format at the same time, so as to reduce the number of clocks required by the hardware coding operation.

Since TILE_HIGHPASS and TILE_FLEXBITS encode the same coefficient, and the differences between the two are that the coefficient is scanned in different orders and different bit sections are generated after the normalization process, wherein TILE_HIGHPASS generates the first half section, such as the most significant bits (MSB) section, TILE_FLEXBITS generates the second half section, such as the least significant bits (LSB) section, and the normalized coefficient is composed of the first half section and the second half section. Thus, in the present invention, a buffer having two ports is provided regarding the coefficient to be encoded by TILE_HIGHPASS and TILE_FLEXBITS such that the coefficient at different positions can be read by TILE_HIGHPASS and TILE_FLEXBITS at the same time. Along with a circuit which can encode both TILE_HIGHPASS and TILE_FLEXBITS and a stream buffer to which two streams can be simultaneously written, two tiles can be encoded at the same time so that the number of clocks required for hardware encoding can be reduced.

Finally, the streams of different types of tiles generated through the encoding process can be connected in a frequency mode stream format after the entire image is encoded, so as to generate a stream conforming to the HD Photo specification.

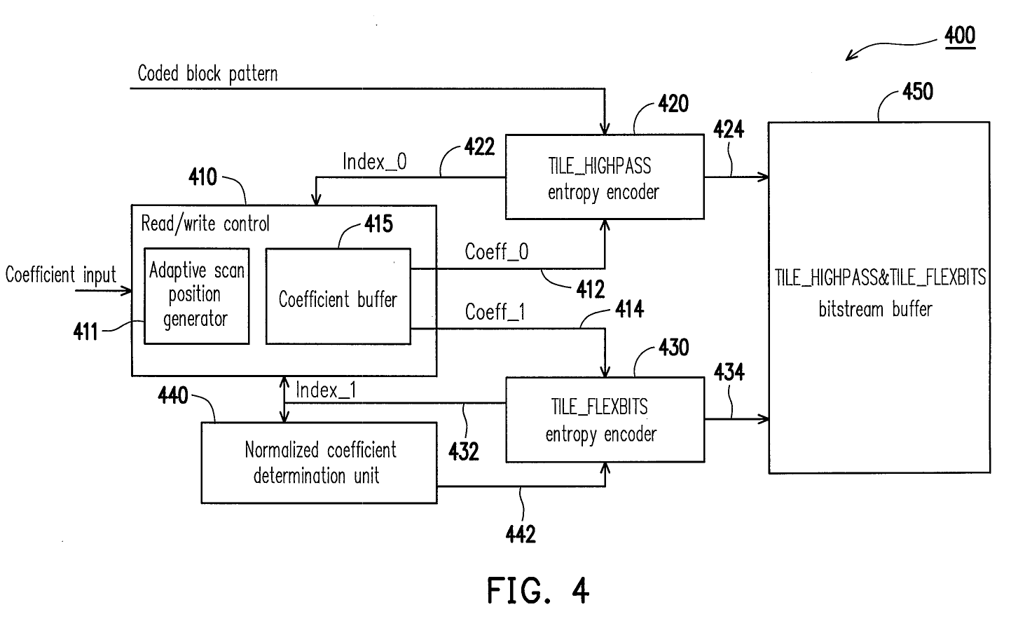

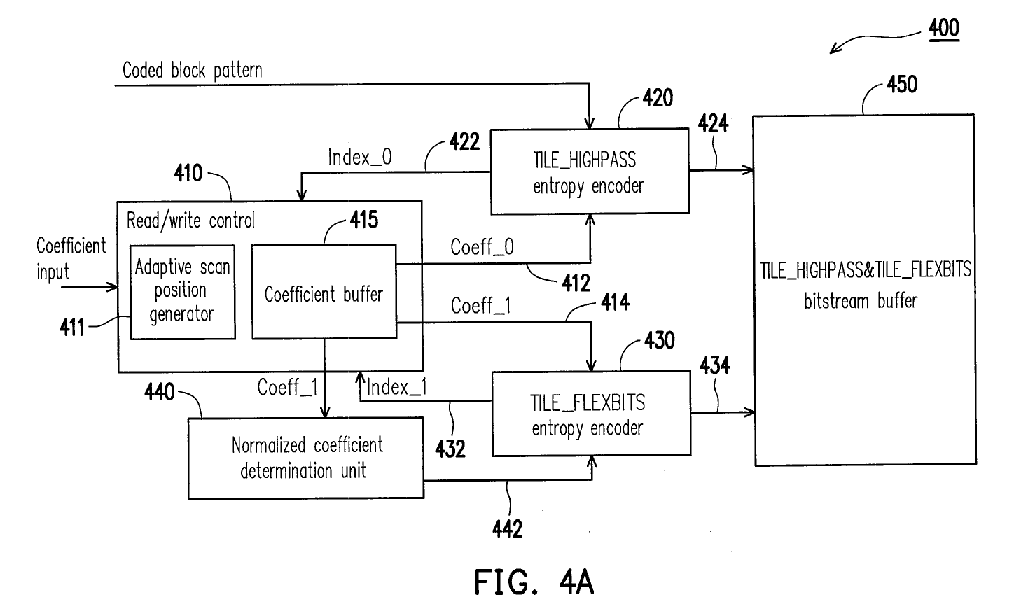

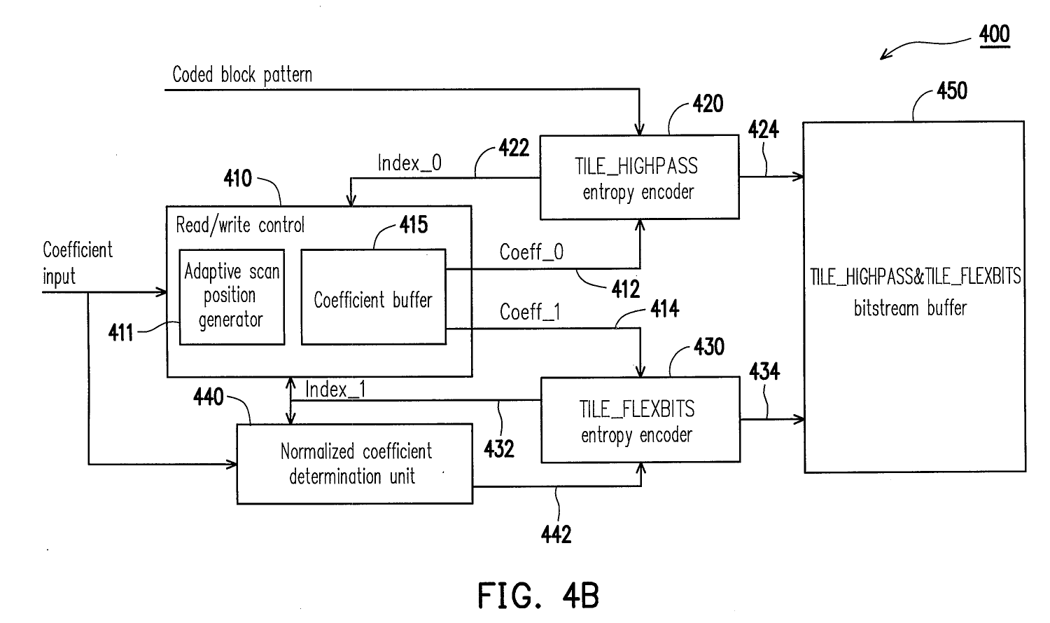

FIGS. 4A and 4B are block diagrams of an encoding circuit which can simultaneously encode TILE_HIGHPASS and TILE_FLEXBITS bitstreams by respectively executing real-time normalization operation or advance normalization operation and storing the result in a normalized coefficient determination unit according to an embodiment of the present invention. The encoding circuit 400 includes a read/write (read or write) control circuit 410 for reading and buffering coefficients, a TILE_HIGHPASS entropy encoder 420 and a TILE_FLEXBITS entropy encoder 430 connected to the read/write control circuit 410, a normalized coefficient determination unit 440, and a TILE_HIGHPASS and TILE_FLEXBITS bitstream buffer 450.

In the encoding circuit 400, the number of clocks required by the entropy encoding is reduced by performing TILE_HIGHPASS encoding and TILE_FLEXBITS encoding together. During the encoding process of the HD Photo format, the processing time of foregoing two encoding takes up more than 90% of the processing time of the entire image. Thus, the processing efficiency can be improved and the processing time can be reduced if the structure in the present invention is adopted.

TILE_HIGHPASS encoding and TILE_FLEXBITS encoding have different coefficient scanning orders, wherein TILE_HIGHPASS is an adaptive scan, and TILE_FLEXBITS is a fixed scan. In the present embodiment, the read/write control circuit 410 accepts two existing encoding orders and respectively converts the coding into correct coefficient positions respectively according to the scanning orders, and then the read/write control circuit 410 reads the required coefficients from the correct coefficient positions and provides the coefficients to the next level encoders.

The read/write control circuit 410 includes an adaptive scan position generator 411 and a coefficient buffer 415 conforming to the HD Photo specification, and the read/write control circuit 410 can read from and write into correct positions through any one of the following methods.

According to one of the methods, when a coefficient is written into the coefficient buffer 415, the coefficient is stored into two coefficient arrays in different orders, wherein the coefficient is stored into one of the coefficient arrays in an adaptive scanning order and into the other coefficient array in a fixed scanning order. Accordingly, while reading the coefficient, the coefficient can be respectively read from the two coefficient arrays in the corresponding orders thereof.

According to another method, when a coefficient is written into the coefficient buffer 415, the coefficient is stored into a coefficient array in a fixed scanning order. Accordingly, while reading the coefficient in the fixed scanning order, the read/white control circuit 410 can directly read the coefficient array in the fixed scanning order. At the same time, while reading the coefficient in the adaptive scanning order,and the adaptive scan position generator 411 transforms the adaptive scanning order into the coefficient positions such that the read/white control circuit 410 reads the coefficients from the coefficient positions. In this way, the read/white control circuit 410 can simultaneously read the coefficients from two coefficient positions from the coefficient array

According to yet another method, when a coefficient is written into the coefficient buffer 415, the coefficient is stored into a coefficient array in an adaptive scanning order. Accordingly, while reading the coefficient in the adaptive scanning order, the read/white control circuit 410 can directly read the coefficient array. At the same time, while reading the coefficient in the fixed scanning order, the reversible adaptive scan position generator 411 transforms the fixed scanning order into adaptive scanning order, namely, coefficient positions, and then the read/white control circuit 410 reads the coefficients at two coefficient positions from the coefficient array.

The coefficient buffer 415 has to be able to read coefficients at at least two different positions simultaneously. In an embodiment of the present invention, the coefficient buffer 415 may be implemented with a memory, such as a static random access memory (SRAM), or a buffer together with two multiplexers.

In the HD Photo specification, TILE_FLEXBITS uses at most the last fifteen bits in a coefficient for encoding. Thus, it is within the scope of the present invention as long as the last fifteen bits in a coefficient support simultaneously reading of two coefficients.

In order to determine whether to encode the sign of a coefficient in TILE_FLEXBITS, in the present embodiment, a circuit (i.e. the normalized coefficient determination unit 440 in FIG. 4) which can determine whether a coefficient read according to the requirement of TILE_FLEXBITS is zero after it is normalized is adopted for achieving foregoing function. The determination result is transmitted by a signal 442 to the TILE_FLEXBITS entropy encoder 430.

The circuit for determining whether a normalized coefficient is zero can be implemented according to different methods. For example, in an embodiment of the present invention, another buffer is provided, and when a coefficient information is written into the coefficient buffer 415, the coefficient is calculated and written in a fixed scanning in real-time. The coefficient is then normalized and whether the normalized coefficient is zero is determined. During the encoding process, whether the normalized coefficient is zero can be understood by reading data in the buffer.

In an embodiment of the present invention, the circuit for determining whether a normalized coefficient is zero includes an operation circuit and a buffer which are both disposed in the normalized coefficient determination unit 440. The operation circuit of the normalized coefficient determination unit 440 can carry out normalization operation, and the buffer thereof can store the result of the normalization operation.

According to another method, the coefficient to be provided to the TILE_FLEXBITS entropy encoder 430 is directly read from the coefficient buffer 415, and whether the normalized coefficient is zero is then determined.

The TILE_HIGHPASS entropy encoder 420 receives a coefficient 412 (Coeff_0 in FIG. 4) which is output by the read/write control circuit 410, obtained by scanning in an adaptive scanning order, and suitable for TILE_HIGHPASS entropy encoding, and the TILE_HIGHPASS entropy encoder 420 performs a TILE_HIGHPASS entropy encoding procedure according to the coefficient 412. Besides, after the TILE_HIGHPASS entropy encoding procedure is completed, the TILE_HIGHPASS entropy encoder 420 outputs a control signal 422 to the read/write control circuit 410 for adjusting the scanning manner. The result obtained in the TILE_HIGHPASS entropy encoding is transmitted through the signal 424 to the bitstream buffer 450.

The TILE_FLEXBITS entropy encoder 430 receives a coefficient 414 (Coeff_1 in FIG. 4) which is output by the read/write control circuit 410, obtained by scanning in a fixed scanning order, and suitable for TILE_FLEXBITS entropy encoding and a signal 442 for indicating whether the normalized coefficient is zero, and the TILE_FLEXBITS entropy encoder 430 carries out a TILE_FLEXBITS entropy encoding procedure according to the coefficient 414 and the signal 442. The result obtained in the TILE_FLEXBITS entropy encoding is transmitted through a signal 434 to the bitstream buffer 450. The TILE_FLEXBITS entropy encoder 430 outputs a control signal 432 (Index_1 in FIG. 4) to the read/write control circuit 410 so as to accomplish aforementioned operation between the adaptive scan position generator 411 and the coefficient buffer 415 for reading from and writing into correct positions.

When the TILE_HIGHPASS entropy encoder 420 and the TILE_FLEXBITS entropy encoder 430 perform the encoding procedures at the same time to process two codes generated simultaneously, in the present embodiment, a bitstream buffer 450 which can connect two codes and write two streams into a stream buffer at the same time is adopted. The bitstream buffer 450 can be implemented with two or more SRAM or buffers.

When foregoing conditions are met, the TILE_HIGHPASS and the TILE_FLEXBITS can perform encoding at the same time and temporarily store the connected encoded stream into the bitstream buffer 450.

Finally, an output circuit may be used for alternatively writing the data in the bitstream buffer 450 into a memory. Once the encoding is completed by other circuits which can perform TILE_DC and TILE_LOWPASS coding, the four streams are connected so as to complete the encoded stream processing in frequency mode in the HD Photo format.

The normalized coefficient determination unit 440 includes an operation circuit which can perform normalization operation and a buffer for storing the normalization result. FIG. 4A is a block diagrams of an encoding circuit which can simultaneously encode TILE_HIGHPASS and TILE_FLEXBITS hardware structures by executing a real-time normalization operation according to an embodiment of the present invention. When the TILE_FLEXBITS entropy encoder 430 receives coefficients 414 (Coeff_1 in FIG. 4A) which are output by the read/write control circuit 410, obtained by scanning in a fixed scanning order, and suitable for TILE_FLEXBITS entropy encoding, the coefficients 414 (Coeff_1) are simultaneously transmitted to the normalized coefficient determination unit 440 to execute a real-time normalization operation. The normalized coefficient determination unit 440 then transmits the result indicating whether the normalized coefficient is zero to the TILE_FLEXBITS entropy encoder 430 through a signal 442.

FIG. 4B illustrates another embodiment of a normalization operation, wherein the coefficient is directly input into the normalized coefficient determination unit 440, and the result of the normalization operation is stored into the normalized coefficient determination unit 440. The TILE_FLEXBITS entropy encoder 430 outputs a control signal 432 (Index_1) to the read/write control circuit 410 so that the read and write operations at correct positions between the adaptive scan position generator 411 and the coefficient buffer 415 can be performed accordingly. Meanwhile, the TILE_FLEXBITS entropy encoder 430 transmits the control signal 432 to the normalized coefficient determination unit 440 to read the normalization result at the correct position and transmits the normalization result to the TILE_FLEXBITS entropy encoder 430 through the signal 442.

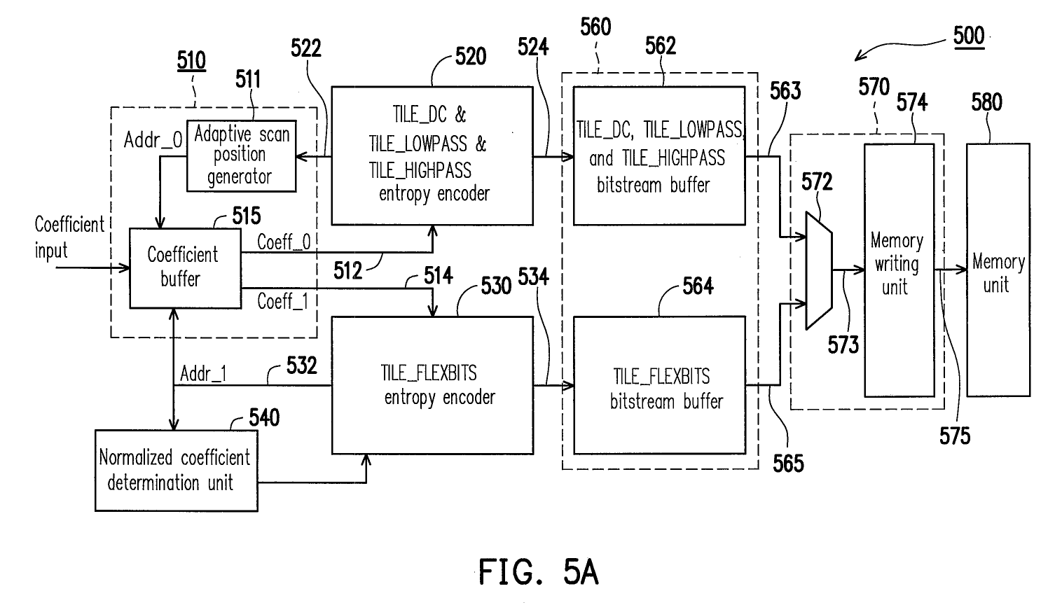

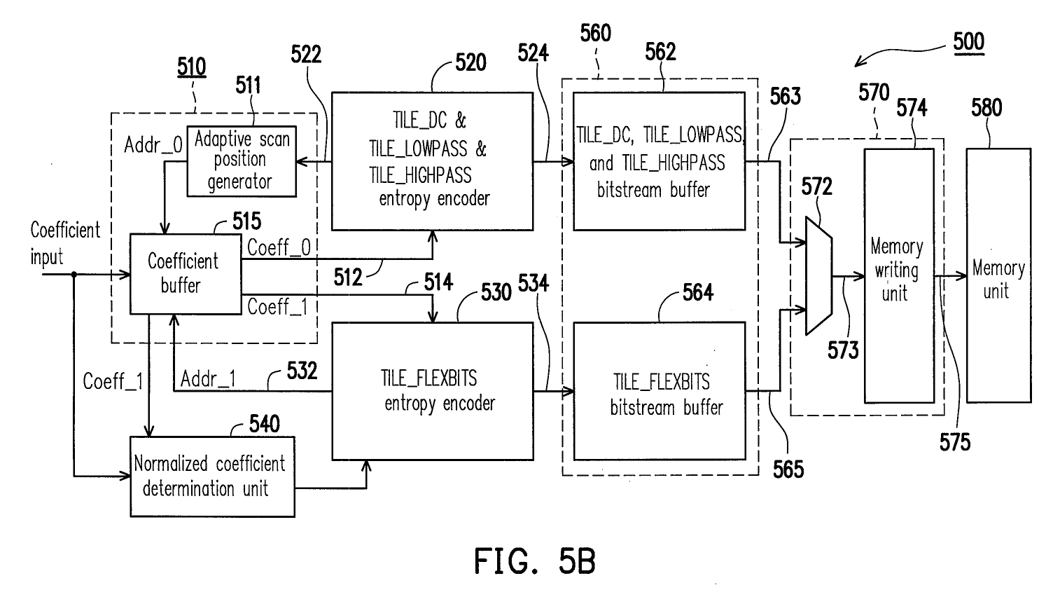

FIG. 5A is a block diagram of an entropy encoder which adopts the circuit which can encode TILE_HIGHPASS and TILE_FLEXBITS at the same time described in foregoing embodiment, wherein an entropy encoding circuit structure 500 which can encode HIGHPASS tiles Tile_HIGHPASS and FLEXBITS tiles Tile_FLEXBITS at the same time is provided.

The entropy encoding circuit structure 500 includes an adaptive scan position generator 511 and a coefficient buffer 515 of a read/write control circuit 510 for reading and buffering coefficients, and the entropy encoding circuit structure 500 further includes an entropy encoder 520 for processing TILE_DC, TILE_LOWPASS, and TILE_HIGHPASS, and a TILE_FLEXBITS entropy encoder 530, a normalized coefficient determination unit 540, a buffer device 560, an output circuit 570, and a memory unit 580. The buffer device 560 includes a TILE_DC, TILE_LOWPASS, and TILE_HIGHPASS bitstream buffer 562 and a TILE_FLEXBITS bitstream buffer 564. The output circuit 570 includes a multiplexer 572 and a memory writing unit 574.

The coefficient buffer 515 can simultaneously read two coefficient buffers at different positions and outputs a coefficient 512 (Coeff_0 in FIG. 5A) and a coefficient 514 (Coeff_1 in FIG. 5A) at the two different positions respectively to the entropy encoder 520 and the TILE_FLEXBITS entropy encoder 530. In another embodiment of the present invention, the coefficient buffer 515 can be implemented with a plurality of buffers and two multiplexers.

The read/write control circuit 510 uses an adaptive scan position generator 511 conforming to the HD Photo specification to transform an adaptive scanning order into coefficient positions for reading coefficients. As shown in FIG. 5A, the adaptive scan position generator 511 receives the control signal 522 from the entropy encoder 520 and adjusts an address signal Addr_0 accordingly, and the coefficient buffer 515 reads the corresponding coefficient (Coeff_0) according to the address signal Addr_0.

In the present embodiment, in order to determine whether to encode the sign of a coefficient in TILE_FLEXBITS, a circuit which can determine whether a coefficient read according to the requirement of TILE_FLEXBITS is zero after it is normalized is adopted to accomplish foregoing function, namely, a normalized coefficient determination unit 540 is adopted for determining whether a normalized coefficient is zero. In the present embodiment, the normalized coefficient determination unit 540 can be implemented with a plurality of buffers and a multiplexer. The content in the buffers can determine whether a normalized coefficient is zero when the coefficient is being written into the coefficient buffer 515 and transmits the determination result to the TILE_FLEXBITS entropy encoder 530.

The entropy encoder 520 is an encoder which can perform TILE_DC, TILE_LOWPASS, and TILE_HIGHPASS entropy encoding and which outputs a control signal 522 to the adaptive scan position generator 511 for adjusting the scanning manner. The TILE_FLEXBITS entropy encoder 530 is an encoder which can perform TILE_FLEXBITS entropy encoding, and the TILE_FLEXBITS entropy encoder 530 can perform fixed length encoding according to the coefficient, whether the normalized coefficient is zero, and the normalized coefficient.

The TILE_FLEXBITS entropy encoder 530 outputs an address control signal 532 (Addr_1 in FIG. 5A) to the read/write control circuit 510 so that the read and write operations at correct positions between the adaptive scan position generator 511 and the coefficient buffer 515 can be performed accordingly. Meanwhile, the TILE_FLEXBITS entropy encoder 530 transmits the address control signal 532 (Addr_1) to the normalized coefficient determination unit 540 to read the normalization result at the correct position and transmits the normalization result to the TILE_FLEXBITS entropy encoder 530.

Additionally, the encoding results of the entropy encoder 520 and the TILE_FLEXBITS entropy encoder 530 are respectively transmitted to the buffer device 560 through a signal 524 and a signal 534. The buffer device 560 is a bitstream buffer which can write two encoding results at the same time, and the buffer device 560 includes a bitstream buffer 562 for storing TILE_DC, TILE_LOWPASS, and TILE_HIGHPASS encoding results and a bitstream buffer 564 which can store TILE_FLEXBITS encoding result.

In another embodiment of the present invention, the buffer device 560 can be implemented with two memories, such as two SRAMs, wherein one of the SRAMs stores the encoded streams of TILE_DC, TILE_LOWPASS, and TILE_HIGHPASS, and the other SRAM stores the encoded stream of TILE_FLEXBITS.

The output circuit 570 can be composed of a multiplexer 572 and a memory writing unit 574. The two input terminals of the multiplexer 572 are respectively connected to the bitstream buffers 562 and 564 through circuits 563 and 565. The output of the multiplexer 572 is transmitted to the memory writing unit 574. The output 575 of the multiplexer 572 can be transmitted to the memory unit 580 by using the memory writing unit 574. The output circuit 570 alternatively reads the data stored in the bitstream buffers 562 and 564 and outputs the data to the memory unit 580; namely, every time the output circuit 570 only reads data from one of the two bitstream buffers 562 and 564 and reads the data stored in the bitstream buffers 562 and 564 alternatively until all the data is read.

According to an image compression method, a coefficient processed through color space transform, lapped transform, quantization, and coefficient prediction of the HD Photo format are written into the coefficient buffer 515 in a fixed scanning order. Meanwhile, the coefficient is calculated and written into the buffer in the normalized coefficient determination unit 540 for recording whether the normalized coefficient is zero. Next, in the present embodiment, the entropy encoder 520 performs TILE_DC and TILE_LOWPASS encoding according to an input coded block pattern and a normalized coefficient and stores the encoding result into the buffer device 560.

Meanwhile, the entropy encoder 520 and the TILE_FLEXBITS entropy encoder 530 respectively perform TILE_HIGHPASS encoding and TILE_FLEXBITS encoding at the same time and store the encoding results into the buffer device 560, and the output circuit 570 alternatively outputs the bitstream data in the bitstream buffers 562 and 564 of the buffer device 560 to the memory unit 580. Finally, four streams in the memory unit 580 which belong to different tiles are recombined in frequency mode so as to complete the encoding of the HD Photo format.

The normalized coefficient determination unit 540 includes an operation circuit for performing normalization operation and a buffer for storing the normalization result. In the present embodiment, the coefficient is directly input into the normalized coefficient determination unit 540, and the normalization result thereof is stored into the normalized coefficient determination unit 540. The TILE_FLEXBITS entropy encoder 530 outputs the address control signal 532 (Add_1) to the coefficient buffer 515 so that the read and write operations at correct positions between the TILE_FLEXBITS entropy encoder 530 and the coefficient buffer 515 can be performed accordingly. Meanwhile, the address control signal 532 (Add_1) is transmitted to the normalized coefficient determination unit 540 to read the normalization result at the correct position, and the normalization result is transmitted to the TILE_FLEXBITS entropy encoder 530.

FIG. 5B is a block diagram of an encoding circuit which can simultaneously encode TILE_HIGHPASS and TILE_FLEXBITS hardware structures by real-time executing normalization operation according to another embodiment of the present invention. When the TILE_FLEXBITS entropy encoder 530 receives a coefficient 514 (Coeff_1 in FIG. 5B) which is output by the read/write control circuit 510, obtained by scanning in a fixed scanning order, and suitable for TILE_FLEXBITS entropy encoding, the coefficient 514 (Coeff_1) is transmitted to the normalized coefficient determination unit 540 to perform a real-time normalization operation. The normalized coefficient determination unit 540 then determines whether the normalized coefficient is zero and transmits the determination result to the TILE_FLEXBITS entropy encoder 530.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An encoding circuit, for simultaneously performing a first encoding procedure and a second encoding procedure on an encoding coefficient, wherein the first encoding procedure is to perform an adaptive scan on the encoding coefficient, and the second encoding procedure is to perform a fixed scan on the encoding coefficient, the encoding circuit comprising:
a read/write control circuit, for reading and buffering the encoding coefficient and simultaneously outputting a first encoding coefficient and a second encoding coefficient;
a first entropy encoder, connected to the read/write control circuit, wherein the first entropy encoder receives the first encoding coefficient, performs the first encoding procedure to the first encoding coefficient, and outputs a first encoded stream data;
a second entropy encoder, connected to the read/write control circuit, wherein the second entropy encoder receives the second encoding coefficient and a normalization signal, performs the second encoding procedure to the second encoding coefficient, and outputs a second encoded stream data; and
a buffer device, connected to the first entropy encoder and the second entropy encoder, wherein the buffer device buffers the first encoded stream data and the second encoded stream data and alternatively outputs the first encoded stream data and the second encoded stream data.

2. The encoding circuit according to claim 1 further comprising:
a normalized coefficient determination unit, connected to the read/write control circuit, wherein the normalized coefficient determination unit normalizes the encoding coefficient, determines whether the normalized encoding coefficient is zero to generate a determination result, and outputs the normalization signal to the second entropy encoder according to the determination result.

3. The encoding circuit according to claim 1, wherein the first encoding procedure and the second encoding procedure are respectively coefficient entropy encoding procedures conforming to TILE_HIGHPASS and TILE_FLEXBITS of HD Photo specification.

4. The encoding circuit according to claim 1, wherein the first entropy encoder further receives a first bit section of the normalized encoding coefficient, and the second entropy encoder further receives a second bit section of the normalized encoding coefficient, wherein the normalized encoding coefficient comprises the first bit section and the second bit section.

5. The encoding circuit according to claim 4, wherein the first bit section is a plurality of most significant bits (MSBs) of the normalized encoding coefficient, and the second bit section is a plurality of least significant bits (LSBs) of the normalized encoding coefficient.

6. The encoding circuit according to claim 1, wherein the first entropy encoder further transmits an adaptive control signal back to the read/write control circuit to adjust the execution manner of the adaptive scan.

7. The encoding circuit according to claim 1, wherein the read/write control circuit comprises a coefficient buffer, and the first entropy encoder and the second entropy encoder simultaneously read data at different positions of the encoding coefficient through the coefficient buffer.

8. The encoding circuit according to claim 7, wherein the encoding coefficient is stored in two coefficient arrays in different orders, wherein the encoding coefficient is stored in one of the two coefficient arrays in an adaptive scanning order and in the other coefficient array in a fixed scanning order.

9. The encoding circuit according to claim 7, wherein the read/write control circuit further comprises an adaptive scan position generator, wherein the encoding coefficient is stored in a coefficient array in the fixed scanning order, when the encoding coefficient is read in the fixed scanning order, the read/write control circuit reads the coefficient array in the fixed scanning order such that the encoding efficient is provided to the second entropy encoder, and when the encoding coefficient is read in the adaptive scanning order, the adaptive scan position generator transforms the adaptive scanning order into a coefficient position and then the read/write control circuit reads the coefficient at the coefficient position from the coefficient array and provides the coefficient to the first entropy encoder.

10. The encoding circuit according to claim 7, wherein the read/write control circuit further comprises a adaptive scan position generator, wherein the encoding coefficient is stored into a coefficient array in the adaptive scanning order, when the encoding coefficient is read in the adaptive scanning order, the read/write control circuit reads the coefficient array in the adaptive scanning order such that the encoding efficient is provided to the second entropy encoder, and when the encoding coefficient is read in the fixed scanning order, the adaptive scan position generator operates inversely to transforms the fixed scanning order into a coefficient position and then read/write control circuit reads the coefficient at the another coefficient position from the coefficient array and provides the coefficient to the second entropy encoder.

11. The encoding circuit according to claim 7, wherein the coefficient buffer is a multi-port static random access memory (SRAM).

12. The encoding circuit according to claim 7, wherein the coefficient buffer comprises a plurality of buffers and two multiplexers.

13. An entropy encoding method, comprising:
buffering an encoding coefficient used for entropy encoding, and simultaneously providing a first encoding coefficient and a second encoding coefficient, wherein the first encoding coefficient is obtained by performing an adaptive scan on the encoding coefficient, and the second encoding coefficient is obtained by performing a fixed scan on the encoding coefficient;
performing a first encoding procedure according to the first encoding coefficient and outputting a first encoded stream data, and at the same time, receiving a normalization signal, performing a second encoding procedure according to the second encoding coefficient and the normalization signal, and outputting a second encoded stream data; and
buffering the first encoded stream data and the second encoded stream data, and outputting the first encoded stream data and the second encoded stream data alternatively.

14. The entropy encoding method according to claim 13, wherein the first encoding procedure and the second encoding procedure are respectively a coefficient entropy encoding procedure conforming to TILE_HIGHPASS and TILE_FLEXBITS of HD Photo specification.

15. The entropy encoding method according to claim 13, wherein after the first encoding procedure is completed, an adaptive control signal is transmitted to adjust the execution manner of the adaptive scan.

16. The entropy encoding method according to claim 13, wherein the step of buffering the encoding coefficient and simultaneously providing the first encoding coefficient and the second encoding coefficient comprises:
buffering the encoding coefficient into an coefficient buffer, and simultaneously reading the coefficient buffer at different positions to revive the first encoding coefficient and the second encoding coefficient.

17. The entropy encoding method according to claim 16, wherein the encoding coefficient is stored in two coefficient arrays in different orders, wherein the encoding coefficient is stored in one of the two coefficient arrays in an adaptive scanning order and in the other coefficient array in a fixed scanning order.

18. The entropy encoding method according to claim 16, wherein the step of buffering the encoding coefficient further comprises:
storing the encoding coefficient in an coefficient array in the fixed scanning order, when the encoding coefficient is read in the fixed scanning order, the coefficient array is read in the fixed scanning order to provide the encoding coefficient as the second encoding coefficient, and when the encoding coefficient is read in the adaptive scanning order, the adaptive scanning order is transformed into a coefficient position through the adaptive scan position generating procedure, and then the coefficient at the coefficient position is read from the coefficient array and is provided as the first encoding coefficient.

19. The entropy encoding method according to claim 16, wherein the step of buffering the encoding coefficient further comprises:
storing the encoding coefficient in an coefficient array in the adaptive scanning order, when the encoding coefficient is read in the adaptive scanning order, the coefficient array is read in the adaptive scanning order to provide the first encoding coefficient, and when the encoding coefficient is read in the fixed scanning order, the fixed scanning order is transformed into a coefficient position through an inverse operation of the adaptive scan position generating procedure, and then the coefficient at the coefficient position is read from the coefficient array and is provided as the second encoding coefficient.

20. An encoding circuit, comprising:
a read/write control circuit, for reading and buffering an encoding coefficient and simultaneously outputting a first encoding coefficient and a second encoding coefficient;
a first entropy encoder, connected to the read/write control circuit, wherein the first entropy encoder receives the first encoding coefficient, performs a plurality of first encoding procedures to the first encoding coefficient, and outputs a plurality of encoded stream data;
a second entropy encoder, connected to the read/write control circuit, wherein the second entropy encoder receives the second encoding coefficient and a normalization signal, performs a second encoding procedure to the second encoding coefficient, and outputs a second encoded stream data; and
a buffer device, connected to the first entropy encoder and the second entropy encoder, wherein the buffer device buffers the first encoded stream data and the second encoded stream data and outputs the first encoded stream data and the second encoded stream data alternatively.

21. The encoding circuit according to claim 20, wherein the first encoding procedures are coefficient entropy encoding procedures conforming to TILE_DC, TILE_LOWPASS, and TILE_HIGHPASS of HD Photo specification, and the second encoding procedure is a coefficient entropy encoding procedure conforming to TILE_FLEXBITS of HD Photo specification.
